(19) United States
(12) Patent Application Publication
(10) Pub. No.: US 2025/0334496 A1
(43) Pub. Date: Oct. 30, 2025

(54) OPTO-MECHANICAL TOWER EXTENSOMETER WITH OPTICS IN SPECIMEN TEST AREA

(71) Applicant: EPSILON TECHNOLOGY CORPORATION, Jackson, WY (US)

(72) Inventor: Wesley J. WOMACK, Jackson, WY (US)

(21) Appl. No.: 19/173,148

(22) Filed: Apr. 8, 2025

Related U.S. Application Data
(60) Provisional application No. 63/638,737, filed on Apr. 25, 2024.

(51) Int. Cl. G01N 3/06; G01N 3/04

(52) U.S. Cl. CPC G01N 3/068; G01N 3/04; G01N 2203/0647

(57) ABSTRACT

Described are opto-mechanical tower extensometers having opposing carriages whose vertical positions relative to each other are actively motor controlled so that deformation of a strain test specimen held between the grips of a mechanical testing system in a test area can be tracked and measured. Upper and lower arm assemblies are used to position optical heads within the specimen test area. Each optical head carries one or more camera assemblies, spot lighting, and optional alignment lasers. Such a system presents a compact design in which the optics can be maintained in close proximity to the test specimen throughout testing.

### CROSS REFERENCE TO RELATED APPLICATIONS

This application claims the benefit of 63/638,737, filed Apr. 25, 2024, the disclosure of which is incorporated by reference herein in its entirety.

The present disclosure is directed generally to materials testing equipment and to optical extensometers for use with materials testing equipment.

### BACKGROUND

Various devices are known for measuring strain under compressive or tensile loads. For instance, in materials testing, devices known as extensometers are frequently used to measure strain of a test specimen by measuring elongation, or change in length (AL) over original length (L); or ΔL/L. Although different configurations are known, the term “extensometer” may refer to most any device that incorporates a sensor capable of measuring relatively small increments of deformation of a test specimen under elongation, or in some cases under compression.

One type of extensometer is a mechanical or “contact” extensometer. These devices use spaced-apart arms having knife edges or other contact elements at their distal ends. The arms may be joined to one another at or near their proximal ends via a flexible transducer assembly. The knife edges are attached to the test specimen at a preset distance from one another (the “gage length” of the extensometer). During testing, the knife edges move with the test specimen as the latter deforms. The deformation or strain is then detected and measured, typically with strain gages contained within the transducer assembly.

While effective, contact extensometers are not well-suited for all testing applications. For instance, extremely fragile materials may present problems for both extensometer attachment and measurement. Moreover, contact extensometers used with materials that fail violently may be damaged by the failing specimen. Still further, contact extensometers require physical attachment to, and detachment from, each test specimen. Such a repetitive procedure may slow throughput when multiple specimens are sequentially tested.

To address these concerns, optical or “non-contact” extensometers are sometimes used. These extensometers may utilize cameras and/or lasers to optically detect deformation by, for example, monitoring marks on the specimen from a remote, non-contacting location. While effective, non-contact extensometers may be prone to various issues. For instance, with non-contact extensometers, variation in the working distance from the extensometer sensor to the test specimen and intrinsic tradeoffs between measurement range, precision, and speed can significantly affect the measurement accuracy and other important performance metrics.

### SUMMARY

Aspects of the present disclosure are directed to optical-mechanical extensometer systems, and methods for use therewith, in which the detection optics are located within a specimen test area, for example in an area directly between upper and lower grips and close to the test specimen, and in some instances positioned about 50 mm or less from the test specimen.

In certain aspects, an opto-mechanical extensometer system is provided for strain measurement of a specimen under deformation testing. The specimen is held at opposing ends within a specimen test area between an upper grip and a lower grip. One or more optical head assemblies are positionable within the specimen test area during deformation testing of the specimen, the optical head assemblies being configured to produce images of reference patterns on the specimen throughout deformation testing such that the images can be used to measure specimen strain. The opto-mechanical extensometer system is used in conjunction with a mechanical testing machine, which generally includes grips for holding a test specimen and controls the movement of its upper grip and/or lower grip along a vertical axis, thereby imparting a tensile load or a compressive load on the specimen. The opto-mechanical extensometer system further includes a controller configured to control movement of the one or more optical head assemblies in response to deformation of the specimen which is imparted by the mechanical testing machine.

In certain aspects, the present disclosure provides an opto-mechanical tower with opposing carriages whose vertical positions relative to each other are actively motor controlled so that deformation of a strain test specimen held between the grips of a mechanical testing system in a test area can be tracked and measured by the optomechanical extensometer system. The opto-mechanical tower system includes upper and lower arm assemblies that are used to position optical head assemblies within the test area. Each optical head carries one or more camera assemblies, spot lighting, and optional alignment lasers. Such a system presents a compact design in which the camera or cameras can be maintained in close proximity to the test specimen throughout testing. As such, the camera assemblies may be comprised of small optics that allow them to be positioned in the constrained area between the grips of the carriages. In some embodiments, this can allow the use of less expensive cameras and lenses. Reducing the working distance between camera and test specimen can also reduce sources of noise in the test environment.

In certain aspects, the use of two independent optical heads with small mobile fields-of-view which do not necessarily overlap allows for improved resolution while maintaining a large overall measurement range, as compared to existing fixed optical systems that must make tradeoffs between resolution, range, and speed. Adequate resolution can be maintained even when using lower resolution cameras, thus increasing speed and reducing measurement response times.

In various aspects, the disclosed devices and methods contemplate variations such as adding a third carriage for transverse measurement or full-field imagery, including a second arm assembly per carriage so that the test specimen can be viewed from multiple directions to increase measurement accuracy, and adding a second camera to the optical head assembly for stereo measurement that can eliminate sensitivity to out-of-plane motion of the specimen.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1A is a schematic side view showing an opto-mechanical extensometer in accordance with certain aspects of the present disclosure, installed upon a typical mechanical testing machine.

FIG. 1B is a schematic perspective view of the opto-mechanical extensometer shown in FIG. 1A, with a specimen in the grips of the mechanical testing machine.

FIG. 2 is a schematic perspective view of another opto-mechanical extensometer in accordance with certain aspects of the present disclosure, installed upon a typical mechanical testing machine.

FIG. 3 shows schematic side views of carriage assemblies and optical head assemblies for use in optical extensometers in accordance with certain aspects of the present disclosure, within the specimen test area defined by the grips of the mechanical testing machine.

FIGS. 4A and 4B are schematic depictions of optical head assembly configurations for use in optical extensometers in accordance with certain aspects of the present disclosure.

FIG. 5 is a schematic depiction of an optical assembly arm attachment mechanism in accordance with certain aspects of the present disclosure.

### DETAILED DESCRIPTION

When selecting an extensometer system for materials testing, various advantages and disadvantages are considered. For example, some mechanical tower extensometer systems suffer from hysteresis and poor dynamic response, often reflecting the arm bearing systems used. Such problems may be overcome by using active mechanical systems that provide a strain-gaged compliant tip on the specimen-contacting arms; the strain gage signal is then used to control position of the arm. However, these active mechanical systems still require specimen contact and are thus susceptible to the problems associated with such contact. Non-contacting, optical extensometers can overcome some of the issues with mechanical tower extensometers. For example, optical extensometers do not contact the specimen and, as such, are less prone to damage at specimen failure. Moreover, stereo optical systems may accommodate in-and out-of-plane specimen motions. Still further, unlike mechanical towers, optical systems have fewer moving parts that can lead to complexity, difficulty of use, and concerns with repeatability.

Existing optical extensometers typically require cameras with large fields of view (FoV) sufficient to cover the specimen length and its elongation. Thus, unless cameras with extremely high resolution or pixel counts are used, resolution and accuracy may suffer. Such high pixel count cameras can limit system speed by requiring more intensive processing power. Moreover, the cameras in optical extensometers are positioned well outside the specimen test area, typically at a distance of 200 mm to 600 mm or more from the specimen, resulting in situations were normal room air currents and other effects noticeably affect measurement accuracy.

To address these and other issues, extensometer designs in accordance with the present disclosure provide an active optical-mechanical tower for strain testing of a sample held between grips, and further including optical head assemblies capable of being positioned in close proximity to the specimen during testing. The position of at least one of the optical head assemblies may be actively controlled to maintain a position with respect to the specimen during testing. Each optical head assembly includes at least one camera assembly and associated spot lighting (as needed), along with optional alignment lasers. During testing, the cameras are located in the specimen test area between the grips, and thus in close proximity to the specimen. As will be appreciated in the various descriptions and embodiments disclosed herein, locating the cameras close to the specimen can address several issues, including allowing the use of lower resolution cameras that may be faster and less costly, and avoiding air current issues while still providing accurate strain measurements and large working range.

Due to the close proximity of optical head assembly components to the specimen and to the grips, there may be concern that specimen breakage and/or movement of the grips (such as during an automatic carriage return after test completion) may cause portions of the specimen or the grip assemblies to contact components of the optical head assemblies, potentially causing issues ranging from misalignment of optics to damage of various optical head components. In accordance with aspects of the present disclosure, these issues can be mitigated by providing for the automatic retraction of the optical head assemblies upon test completion, and/or by mounting optical head components in a break-away fashion that prevents or lessens the extent of damage due to undesired impacts to the optical head assembly components. Break-away mounting may include magnetic mounting, spring-hinged mounting, and the like, and can be accomplished in a manner that allows electrical connection between the optical head assembly components and controller electronics of the extensometer.

An optical extensometer measures the strain in a material by optically observing changes in its dimensions due to deformation. The primary function of an optical extensometer is to measure changes in length, usually elongation or contraction, of a specimen subjected to mechanical forces. In a typical setup, a test specimen is mounted between carriage grips of the testing machine, which applies the mechanical load. A pattern referenced to the test specimen is then monitored by the optics of the extensometer system to detect deformation. The pattern may be reference marks made on the test specimen, a “natural” pattern, texture, or artifact already existing on the test specimen, a feature of the specimen surface that is enhanced by speckle caused by the projection of coherent laser light, and so forth. As used herein, the term “reference pattern” as related to a test specimen means any pattern, texture, feature, artifact, or marking, whether provided, already existing, or enhanced, that can be used to monitor specimen deformation during extensometer testing.

When the reference pattern includes reference marks made on the specimen, the marks are often in the form of dots, lines, or patterns that can be easily tracked to determine specimen deformation under strain, including in some circumstances in multiple directions. This may be in the form of a dot on either end of the specimen in the vicinity of the grips, two sets of dots on either end of the specimen, a diamond pattern of four dots covering the ends and the middle of the specimen, and so forth. As mentioned, natural surface texture of the specimen or laser speckle may also suffice as a reference pattern. A light source typically projects a beam of light onto the specimen to enable a camera or other optical detector to capture the image of the reference pattern on the specimen. As the specimen undergoes deformation, the reference pattern changes, and these changes are monitored and measured using the camera.

The captured images are then analyzed by the extensometer software. The software determines the displacement or deformation of the specimen by comparing the initial pattern with the deformed pattern. This analysis may involve tracking specific points on the pattern or measuring changes in distances between points. From the changes in the pattern detected by the optical system, the extensometer calculates the strain in the material. Strain is a measure of how much the material has deformed relative to its original dimensions. The calculated strain values are typically communicated to the mechanical testing machine and/or displayed on a monitor or recorded for further analysis. This data helps engineers and researchers understand how a material responds to different levels of stress and provides insights into its mechanical properties.

Optical extensometers offer advantages such as non-contact measurement, high accuracy, and the ability to measure strain in real-time. They are particularly useful in applications where traditional extensometers may be challenging to use, such as testing of brittle materials. While optical extensometers offer several advantages, they also have some drawbacks that may impact their suitability for certain applications. For example, optical extensometers can be sensitive to environmental conditions such as changes in lighting, temperature, vibrations, and air currents. Variations in these conditions may affect the accuracy of measurements and require careful control or compensation. Optical extensometers rely on a clear line of sight between the light source, the specimen surface, and the detector. In some testing setups or with complex specimen geometries, maintaining an unobstructed line of sight may be challenging. Optical extensometers can be more expensive compared to some other types of extensometers due to high-resolution cameras and lenses. Setting up an optical extensometer can be more complex compared to traditional extensometers. Accurate measurements generally require calibration and proper alignment of the optical components, which may require skilled personnel and time. External factors such as stray light can also impact the performance of optical extensometers. The resolution of an optical extensometer may be limited by the capabilities of the imaging assembly. Achieving very high resolution for precise measurements may be challenging, especially when a relatively large working distance, large field of view (working range), and/or high speed are required.

Optical extensometers in accordance with the present disclosure can be used to overcome some of the tradeoffs associated with these challenges by positioning optical detection assemblies within the specimen test area between the grips holding the specimen in place. Close proximity of the cameras to the test specimen can reduce sensitivity to lighting, temperature, vibrations, and air currents. Locating the cameras in the specimen test area can greatly simplify setup and alignment, while providing clear line of sight to the test specimen. Placing optical head assemblies close to the specimen and between the grips can allow the use of less expensive, smaller, and lower-resolution cameras without sacrificing accuracy or precision while improving speed and reducing demands on the processor. Other advantages will be apparent to one of skill in the art from the descriptions and embodiments set forth herein.

Reference will now be made to the drawings, which depict one or more aspects described in this disclosure. However, it will be understood that other aspects not depicted in the drawings fall within the scope of this disclosure. Like numbers used in the figures refer to like components, steps, and the like. However, it will be understood that the use of a reference character to refer to an element in a given figure is not intended to limit the element in another figure labeled with the same reference character. In addition, the use of different reference characters to refer to elements in different figures is not intended to indicate that the differently referenced elements cannot be the same or similar.

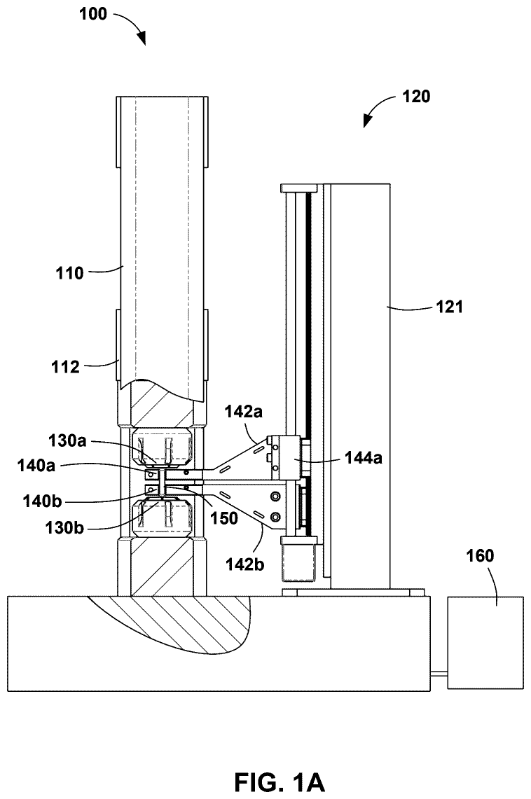

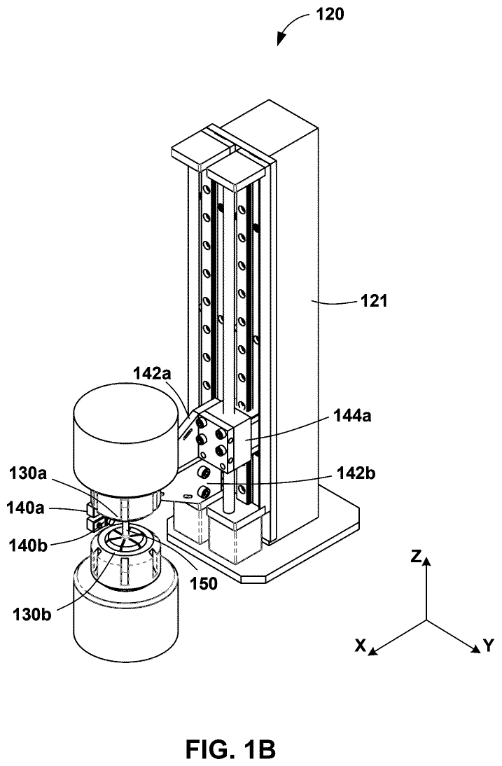

FIGS. 1A and 1B schematically depict an opto-mechanical extensometer 120 and representative mechanical testing machine 100. The testing machine 100 includes a mechanical tower 110 on which components can be moved by a motor controlled by a controller module 160. A test specimen 150 is held between an upper grip 130a and a lower grip 130b. Upper grip 130a is attached to upper carriage 112 such that upper grip 130a can be moved relative to lower grip 130b to put a tensile load or a compressive load on the specimen 150 for testing. While the testing machine 100 is shown with a moving upper carriage 112, it will be understood and appreciated that a testing machine could also include a similar moving lower carriage, or multiple moving carriages.

Without loss of generality, as used in the present disclosure the terms strain testing and deformation testing include both elongation and compression of the specimen 150 in the vertical direction, which by convention is called the Z-axis (indicated in FIG. 1B). The deformation measured during strain testing typically relates to deformation in the vertical direction, but can additionally or alternatively include horizontal (or lateral) deformation (any direction in the X-Y plane indicated in FIG. 1B). Measuring deformation of the specimen 150 under tensile or compressive loading can be used for tensile and compressive strain testing as well as testing for creep, fatigue, material failure mechanisms, and so forth, as is well understood in the art.

Extensometer system 120 includes optical head assemblies 140a and 140b that are attached to arm assemblies 142a and 142b, respectively, which in turn are movably coupled to a mechanical tower 121 for controlling the vertical positioning of the optical head assemblies 140a and 140b. For example, arm assembly 142a may be coupled to movable carriage 144a for the vertical positioning of optical head assembly 140a during initial setup, testing, and so forth. While extensometer system 120 is shown to be separate from mechanical testing machine 100, it will be appreciated that the two systems may be integrated into the same housing, enclosure, or structure. Whether integrated or not, the movement mechanisms for the optical head assemblies 140a and 140b remain independent from the movement mechanisms of carriage 112 and the specimen grips 130a and 130b. Through the positioning and operation of the opto-mechanical tower 121, the arm assemblies 142a and 142b, or a combination of both, and thereby the optical head assemblies 140a and 140b, may be positioned within a specimen test area between the upper grip 130a and lower grip 130b.

The specimen test area can be envisaged as a cylinder-like volume that contains the test specimen and extends a short distance horizontally (that is, in the X-Y plane as indicated in FIG. 1B) from the test specimen. For example, the volume contained within a distance of about 50 mm or less from the specimen may be considered the test area. The test area may also be considered as the region directly between the grips that hold the test specimen in place and extending far enough horizontally to encompass an area in which an object would be in danger of interfering with the test procedure or in danger of being contacted by the grips or by the specimen.

Optical head assemblies 140a and 140b are configured to maintain line-of-sight imaging capability of reference patterns on the test specimen 150 throughout testing. For example, at initial setup optical head assembly 140a may be aligned to image a first reference pattern on the test specimen 150 and optical head assembly 140b may be aligned to image a second reference pattern on the test specimen 150. Optical head assemblies 140a and 140b maintain imaging-capable alignment with respect to the reference patterns throughout testing. For example, in setups where carriage 112 moves upper grip 130a vertically upward to put a tensile load on specimen 150 while lower grip 130b remains stationary, optical head assembly 140a can move in concert with upper grip 130a to maintain imaging alignment while optical head assembly 140b remains stationary or moves to a lesser degree than the optical head assembly 140a.

In certain embodiments, for example in embodiments where a single camera is used for each optical head assembly, it may be preferred to maintain a substantially horizontal line of sight between the camera and the specimen reference pattern being imaged. By maintaining horizonal opposition to the reference patterns on the specimen, out-of-plane scaling errors can be mitigated without using stereo or telecentric optics, thereby making possible much less expensive optics designs. In certain other embodiments, the optical head assemblies 140a and 140b, while equipped to travel, need not perfectly track the reference patterns on the test specimen so long as the reference patterns remain in the view of the respective camera(s).

Systems in accordance with the present disclosure such as shown in FIGS. 1A and 1B may be designed such that the optical head assemblies and/or optical assembly arms actively respond to vertical pressure, for example so that they move away from a downward-moving crosshead to avoid being damaged. In a similar way, responsiveness to vertical pressure can be used by an operator to position the optical head assemblies and arms initially, to set the height and gage length of a new test specimen.

In contrast to extensometer systems and methods in accordance with the present disclosure, optics positioned outside the test area, for example much more than 100 mm from the specimen, would require larger and significantly more expensive optics to maintain a tight field of view. The need to use larger optics can create a situation where two adjacent optical detectors cannot be placed near one another while each being positioned horizontally relative to the tracked specimen marks. This may limit the application of such large optics to larger specimens that accommodate larger initial spacing between carriages. While tilting the large optics off of a horizontal axis can overcome such space limitations, tilting can introduce out-of-plane errors. The use of stereo optics may overcome the out-of-plane errors, but also doubles the camera count, adding expense and complexity.

Instead, in accordance with the present disclosure, the ability to position the optics inside the test area, as described by various aspects and embodiments herein, allows the use of less expensive optical designs that are more easily aligned and used, while maintaining good performance and utility even for smaller specimens. Another benefit of close camera-to-specimen proximity relates to air currents which distort the light path and reduce accuracy regardless of the camera resolution and lens selection. This distortion grows exponentially with working distance, and so close proximity of the optical head to the specimen can provide significant advantages, as recognized in the present disclosure.

As will be appreciated in reference to the various descriptions provided herein, other benefits can be derived from having the optics in close proximity to the specimen. If small, inexpensive optics are used but are placed far away, then the field of view per camera will increase, significantly degrading the measurement accuracy. Long focal length lenses for use with very inexpensive cameras are not readily available. For the larger cameras, such lenses are available but prohibitively large and expensive.

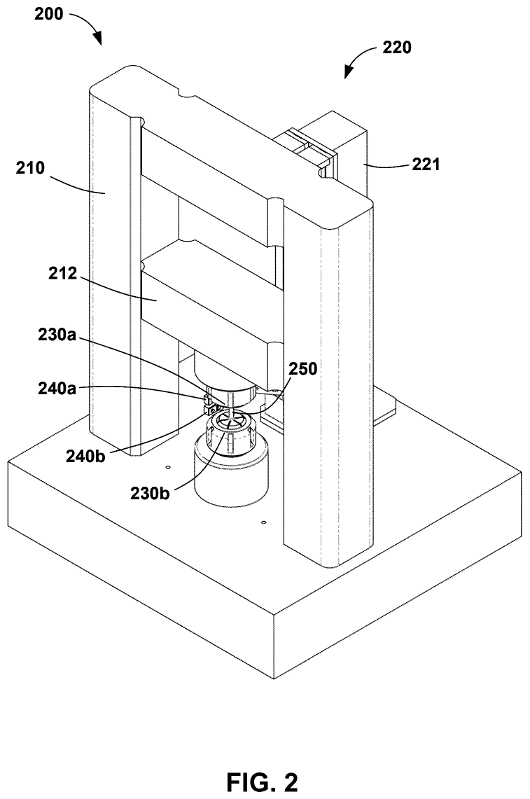

FIG. 2 is a perspective view of a two-column mechanical testing system 200 that incorporates an opto-mechanical extensometer 220 in accordance with the present disclosure. The testing system 200 has one or more columns 210 such that a carriage 212 can be moved up and down, for example using a system of rails in the columns. Opto-mechanical extensometer 220 includes a mechanical tower 221 to control optical head assemblies 240a and 240b, which can be positioned in the test area where test specimen 250 is held between an upper grip 230a and a lower grip 230b of the mechanical testing system 200. It will be appreciated that opto-mechanical extensometer designs that provide for optical head assemblies to be positioned and maintained within the test area between grips during strain testing of a specimen can be accommodated in various types of mechanical testing machines, various types of grips, and various types of specimens.

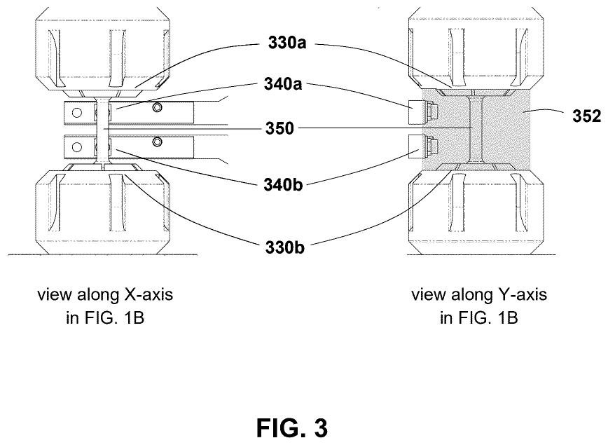

FIG. 3 schematically shows side views of a portion of an opto-mechanical extensometer system that includes the specimen test area 352. On the left in FIG. 3 is a side view shown along the X-axis (in reference to extensometer 120 of FIG. 1B), and on the right is a side view shown along the Y-axis (in reference to extensometer 120 of FIG. 1B). Upper grip 330a and lower grip 330b of a mechanical testing machine are movable relative to each other in the vertical direction, or Z-axis (in reference to extensometer 120 of FIG. 1B). In some systems, lower grip 330b remains stationary while upper grip 330a moves up and down. The movement between the carriages/grips imparts a tensile load (elongation) or a compressive load (compression) to a test specimen 350 held in place using grips 330a and 330b. An upper optical head assembly 340a is positioned to monitor a reference pattern on an upper portion of the test specimen 350, and a lower optical head assembly 340b is positioned to monitor a reference pattern on a lower portion of the test specimen 350. One or both of the optical head assemblies 340a and 340b may be movable so that they can track and monitor the reference patterns on the test specimen 350. As indicated in the view along the Y-axis on the right side of FIG. 3, optical head assemblies 340a and 340b are positioned near the specimen 350 and within the specimen test area 352 between the upper and lower grips.

Optical head assemblies 340a and 340b each include at least one optical detector such as a camera, a light source to illuminate the test specimen, and one or more optional alignment laser(s). The optical head assemblies are positioned such that at least one camera or optical detector is located between the specimen grips and in the specimen test area 352.

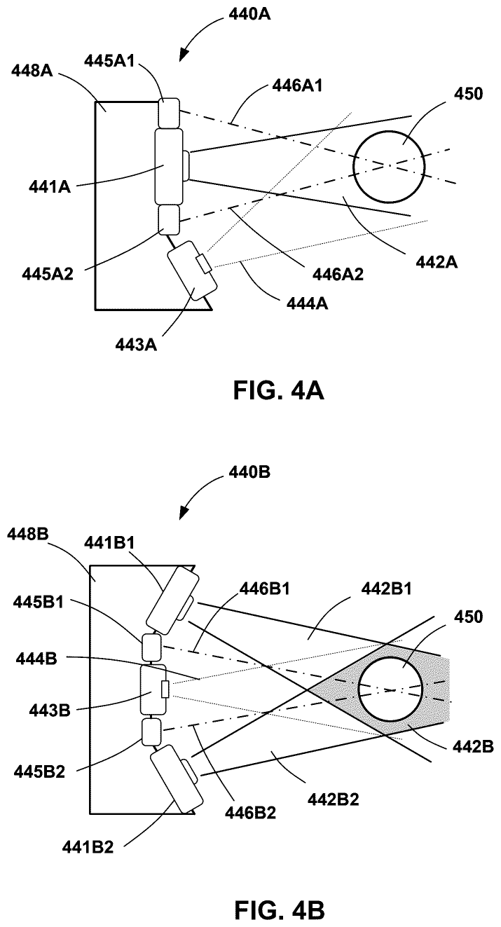

FIG. 4A schematically shows an example of a single-camera optical head assembly 440A in accordance with certain aspects of the present disclosure. Optical head assembly 440A includes an assembly body 448A that houses a camera 441A that is centrally located so that its field of view 442A includes test specimen 450. Optical head assembly also includes a light source 443A to illuminate the specimen 450 as indicated by light cone 444A. Illuminating the specimen ensures sufficient light for imaging. Optionally, optical head assembly 440A includes lasers 445A1 and 445A2 useful in alignment of the optics relative to the specimen.

FIG. 4B schematically shows an example of a two-camera optical head assembly 440B in accordance with certain aspects of the present disclosure. Optical head assembly 440B includes an assembly body 448B that houses two cameras, camera 441B1 and camera 441B2. The cameras 441B1 and 441B2 are positioned such that their overlapping fields of view 442B includes test specimen 450. By using such a stereo camera configuration, errors due to out-of-plane motion of the specimen can be corrected. Centrally placed light source 443B illuminates the specimen 450 as indicated by light cone 444B. Optionally, optical head assembly 440B includes lasers 445B1 and 445B2 useful in alignment of the optics relative to the specimen.

In reference to FIGS. 4A and 4B, out-of-plane motion insensitivity can be mitigated in configurations utilizing designs similar to optical head assembly 440A or optical head assembly 440B. For single camera configurations, the optical head assembly can include a camera positioned directly in horizontal opposition to the position or mark on the specimen that is being tracked. This positioning mitigates out-of-plane scaling errors without the need to use stereo or telecentric optics. For multi-camera configurations, the optical head assembly can include two or more cameras and utilize stereoscopic methods to measure and resolve out-of-plane motions. In multi-camera configurations, the cameras can be arbitrarily located. In addition, multiple arm assemblies can be provided that each include an optical head for imaging the same area of the test specimen from different angles or perspectives, for example to simultaneously image opposite sides of the specimen. In such multi-perspective configurations, the optical heads may or may not have overlapping fields of view.

In certain circumstances and environments, the positioning of the optical heads within the specimen test area may put the optics at elevated risk of damage due to impact from the specimen, the operator, the specimen grips, moving carriages, and so forth. In order to accommodate these risks, the optical head assemblies may include active means of contact avoidance, which may include mechanisms to move the optical head assemblies vertically or horizontally away from the test space or components of the test frame. For example, the optical assembly arms may be automatically moved back into an initial position prior to the test carriage returning to a set-up position at the completion of a test, thereby avoiding a collision between the optical head assemblies and the test carriages. As another example, the optical head assembly arms may be designed to swing on hinges in the horizontal plane so that they can be retracted from the test area. Such swinging retraction may be done manually by an operator or automatically by the system. In addition or alternatively, the optical head assemblies or assembly arms may include passive means of avoiding damage when contacted or impacted, such as spring- mounted, hinged, or magnetically-attached components that absorb impacts and/or easily detach upon contact without causing damage, and that preferably allows the optics to be easily repositioned afterwards.

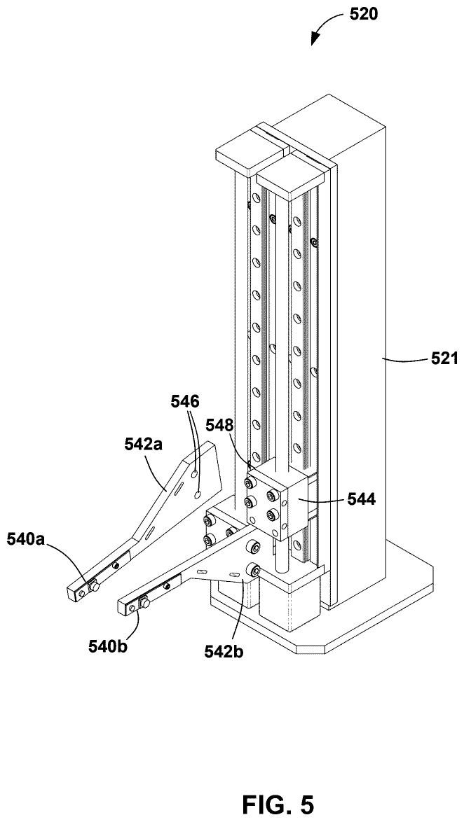

FIG. 5 schematically shows an example of a break-away mounting system for attaching an optical assembly arm 542a to movable carriage 544 on the tower 521 of an opto-mechanical extensometer 520. In this example, a lower optical assembly arm 542b having optical head assembly 540b mounted thereon is shown attached to mechanical tower 521. Lower assembly arm 542b may be stationary or attached to a movable carriage. Upper assembly arm 542a includes magnetic attachment features 546 that engage with corresponding attachment features 548 on carriage 546. The magnetic attachment features 546 and 548 are designed such that, when attached, the appropriate electrical connections are made for using and controlling the camera(s), illumination device(s), laser(s), or other components of optical head assembly 542a. Protrusions, notches, or other physical features can be included on one or both of the upper assembly arm 542a and carriage 544 to promote proper initial alignment and integrity of position throughout the range of movement under all expected testing environments and conditions. Likewise, the strength of the magnetic mounting should be enough to provide necessary rigidity during testing while allowing the arm to break away from the carriage upon a contact force that is enough to induce break-away but still insufficient to damage the optics.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (for example, all described acts or events may not be necessary to carry out the techniques). In addition, while certain aspects of this disclosure are described as being performed by a single module or unit for purposes of clarity, it should be understood that the techniques of this disclosure may be performed by a combination of units or modules.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (for example, RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

As used herein, the term “configured to” may be used interchangeably with the terms “adapted to” or “structured to” unless the content of this disclosure clearly dictates otherwise.

As used herein, the term “or” refers to an inclusive definition, for example, to mean “and/or” unless its context of usage clearly dictates otherwise. The term “and/or” refers to one or all of the listed elements or a combination of at least two of the listed elements.

As used herein, the phrases “at least one of” and “one or more of” followed by a list of elements refers to one or more of any of the elements listed or any combination of one or more of the elements listed.

As used herein, the terms “coupled” or “connected” refer to at least two elements being attached to each other either directly or indirectly. An indirect coupling may include one or more other elements between the at least two elements being attached. Further, in one or more embodiments, one element “on” another element may be directly or indirectly on and may include intermediate components or layers therebetween. Either term may be modified by “operatively” and “operably,” which may be used interchangeably, to describe that the coupling or connection is configured to allow the components to interact to carry out described or otherwise known functionality.

As used herein, any term related to position or orientation, such as “proximal,” “distal,” “end,” “outer,” “inner,” “upper,” “lower” and the like, refers to a relative position and does not limit the absolute orientation of an embodiment unless its context of usage clearly dictates otherwise.

All scientific and technical terms used herein have meanings commonly used in the art unless otherwise specified. The definitions provided herein are to facilitate understanding of certain terms used frequently herein and are not meant to limit the scope of the present disclosure.

The singular forms “a,” “an,” and “the” encompass embodiments having plural referents unless its context clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

What is claimed is:

1. An opto-mechanical extensometer system for strain measurement of a specimen under deformation testing and held at opposing ends within a specimen test area between an upper grip and a lower grip of a mechanical testing system, the opto-mechanical extensometer system comprising:
one or more optical head assemblies positionable within the specimen test area during deformation testing of the specimen, each of the one or more optical head assemblies configured to produces images of an associated reference pattern on the specimen throughout deformation testing such that the images can be used to measure specimen strain; and
a controller configured to control movement and/or operation of the one or more optical head assemblies.

2. The opto-mechanical extensometer system of claim 1, wherein the one or more optical head assemblies are positionable within about 50 mm or less from the specimen, within about 30 mm or less from the specimen, or within about 10 mm or less from the specimen during deformation testing.

3. The opto-mechanical extensometer system of claim 1, wherein at least one of the one or more optical head assemblies includes a camera configured to maintain a substantially horizontal line of sight between the camera and the associated reference pattern on the specimen throughout deformation testing.

4. The opto-mechanical extensometer system of claim 1, wherein each of the one or more optical head assemblies includes a camera configured to produce the images and a light source configured to illuminate the specimen.

5. The opto-mechanical extensometer system of claim 4, wherein each of the one or more optical head assemblies further includes a laser alignment system.

6. The opto-mechanical extensometer system of claim 1, wherein the one or more optical head assemblies comprises an upper optical head assembly and a lower optical head assembly each independently movable relative to the other along a vertical axis.

7. The opto-mechanical extensometer system of claim 1, wherein at least one of the one or more optical head assemblies is movable to maintain line-of-sight imaging of the associated reference pattern.

8. The opto-mechanical extensometer system of claim 7, wherein the at least one of the one or more optical head assemblies is mounted to an associated movable carriage.

9. The opto-mechanical extensometer system of claim 8, wherein the at least one of the one or more optical head assemblies is mounted to the associated movable carriage using a magnetic mounting system configured to break away when the at least one of the one or more optical head assemblies is contacted by a sufficient force.

10. The opto-mechanical extensometer system of claim 9, wherein the magnetic mounting system is configured to electrically connect the at least one of the one or more optical head assemblies to the controller.

11. The opto-mechanical extensometer system of claim 1, wherein the one or more optical head assemblies are configured to retract away from the specimen test area.

12. The opto-mechanical extensometer system of claim 1, wherein the one or more optical head assemblies includes stereo optics.

13. An opto-mechanical extensometer system for use with a mechanical testing machine for strain testing a specimen held between grips of the mechanical testing machine, the opto-mechanical extensometer system comprising:
an opto-mechanical tower having opposing upper and lower carriages whose vertical positions relative to each other are actively motor controlled;
an upper arm assembly attached to the upper carriage and including an upper optical head assembly that includes one or more upper cameras and upper spot lighting, the upper arm assembly configured to position the upper optical head assembly between the grips of the mechanical testing machine; and
a lower arm assembly attached to the lower carriage and including a lower optical head assembly that includes one or more lower cameras and lower spot lighting, the upper arm assembly configured to position the upper optical head assembly between the grips of the mechanical testing machine,
wherein the upper optical head assembly and lower optical head assembly are configured to track and measure deformation of the specimen.

14. The opto-mechanical extensometer system of claim 13, wherein the upper optical head assembly and lower optical head assembly are configured to track and measure vertical deformation of the specimen, and further comprising a transverse optical head assembly configured to track and measure horizontal deformation of the specimen.

15. The opto-mechanical extensometer system of claim 13, wherein at least one of the one or more upper cameras and one or more lower cameras comprises a stereoscopic camera configuration.

16. The opto-mechanical extensometer system of claim 13, wherein the upper optical head assembly further includes an upper laser alignment system, and wherein the lower optical head assembly further includes a lower laser alignment system.

17. The opto-mechanical extensometer system of claim 13, wherein at least one of the one or more upper cameras and one or more lower cameras comprises a multiple camera configuration configured to track and measure deformation of the specimen from different perspectives relative to the specimen.

18. The opto-mechanical extensometer system of claim 17, wherein the multiple camera configuration provides non-overlapping fields of view.

19. The opto-mechanical extensometer system of claim 13, wherein the upper arm assembly is attached to the upper carriage by a break-away mounting system.

20. The opto-mechanical extensometer system of claim 19, wherein the break-away mounting system is a magnetic mounting system.
